(19) United States
(12) Patent Application Publication
(10) Pub. No.: US 2015/0231805 A1
(43) Pub. Date: Aug. 20, 2015

(54) PROCESS AND DEVICE FOR THE CONSOLIDATION AND INDUCTION FORMING OF A PREFORM MADE OF A COMPOSITE MATERIAL

(71) Applicant: Airbus Operation (S.A.S.), Toulouse (FR)

(72) Inventors: Florian CHOTARD, NANTES (FR); Cyrille COLLART, NANTES (FR)

(21) Appl. No.: 14/623,140

(22) Filed: Feb. 16, 2015

(30) Foreign Application Priority Data
Feb. 18, 2014 (FR) 1451292

(51) Int. Cl. B29C 43/56; B29C 43/52

(52) U.S. Cl. CPC B29C 43/56; B29C 43/52; B29C 2043/568

(57) ABSTRACT

A consolidation device comprising a heating unit provided with at least one two-sided inductor, two walls of which are distributed on both sides of a support on which the preform is positioned, comprising carbon fibers embedded in a resin and oriented in a main direction belonging to a principal plane, as well as particles of ferromagnetic material. The two-sided inductor is capable of generating a uniform magnetic field, in order to achieve induction heating of the preform. The device further comprises tilting elements for tilting at least one of the following elements: the preform and the two-sided inductor, so as to orient the direction of incidence of the magnetic field in relation to the principal plane at an angle other than 90° and other than zero.

### CROSS-REFERENCES TO RELATED APPLICATIONS

This application claims the benefit of the French patent application No. 1451292 filed on Feb. 18, 2014, the entire disclosures of which are incorporated herein by way of reference.

### BACKGROUND OF THE INVENTION

The invention relates to the fabrication of parts made of composite materials in the aeronautical field. It relates to a process and a device for the consolidation and induction forming of a part made of a composite material.

Parts made of composite materials are fabricated from a preform usually comprising carbon fibers embedded in a resin which are deposited by drape forming, for example, so as to create folds superposed one on top of the other. In each fold the fibers are aligned in a main direction (0°, 45°,90°). The planes of the carbon fiber folds are parallel to one another and define a plane referred to as the principal plane. Moreover, the methods involved in fabricating a preform of this kind generate points of contact between the folds, the distribution of said points of contact being random and strongly dependent on the nature of the resin and the speed at which the carbon fibers are deposited.

The consolidation of a part made of composite material is performed by heating the preform previously obtained to a temperature causing the structure of the preform to soften. In this way, the softened preform is going to be able to be consolidated and possibly adapted in a defined form, by means of a mold, for example. In order to consolidate the preform, convection consolidation (or baking) devices are generally used, for example an autoclave, in which heating is performed by a transfer of heat energy between a fluid and the part to be consolidated. However, controlling the temperature of the part to be consolidated is a delicate process and this method of consolidation does not guarantee uniformity of the energy contribution and therefore of the consolidation.

The heating of a preform may likewise be achieved by induction by applying a magnetic field about the preform to be consolidated. Document EP1326741B1 describes a polymer matrix composition comprising ferromagnetic elements dispersed in a polymer matrix and a process allowing heat to be generated by uniform hysteresis in said composition, in order to control the consolidation temperature of this composition precisely.

Moreover, it is known that under the effect of a magnetic field applied to a part, induced currents circulate in said part and generate a temperature increase by a Joule effect linked to the electrical resistance of the material in which these currents circulate.

In a preform made of composite material, the induced currents circulate in two directions:

a main direction in the folds, along the carbon fibers of the preform, and

a secondary direction perpendicular to the main direction between the folds, along which the points of contact are positioned between the folds.

The preform is therefore subject to a temperature gradient, for example of the outer surface towards the center of the part. Consequently, the consolidation is not uniform throughout the preform and the heating time has to be sufficient to ensure a correct consolidation temperature throughout the volume of the preform.

Hence, during the consolidation of a preform made of composite material, the resin of which contains ferromagnetic particles, as described in document EP1326741B1, the two induction baking phenomena, in other words induction current heating and hysteresis heating, coexist.

However, the induction current heating is dominant over the hysteresis heating, which harms the uniformity of the baking. Consequently, preforms comprising variations in thickness or having complex forms cannot be correctly realized with this kind of consolidation device.

### SUMMARY OF THE INVENTION

A problem addressed by the present invention is that of overcoming all or part of this disadvantage. It relates to a consolidation and induction forming process for a preform made of composite material comprising carbon fibers embedded in a resin and oriented in a main direction belonging to a principal plane, said process comprising the following stages or steps:

preparation of a uniform mixture comprising the resin and at least one ferromagnetic material presented in the form of particles;

formation of a preform by embedding the carbon fibers in the mixture; and

induction heating of the preform up to a defined temperature referred to as the process temperature, said temperature being substantially equal to the Curie temperature of the ferromagnetic material, through generation by means of a two-sided inductor of a uniform magnetic field in the preform in a direction of incidence.

According to the invention, said process is noteworthy in that it further comprises a tilting stage or step of at least one of the following elements: the preform and the two-sided inductor, so as to orient the direction of incidence of the magnetic field in relation to the principal plane at an angle other than 90° and other than zero.

Hence, the process according to the invention allows the dominance of hysteresis heating over induction current heating to be optimized and the preform therefore to be heated uniformly, both over the outer section and at the center of the preform made of composite material composed of carbon fibers embedded in a resin comprising ferromagnetic particles. The preform is therefore integrally baked at the same speed and in the same time, which reduces the baking time. Moreover, the process allows an accuracy to be achieved due to the temperature that the part reaches during its baking, because it is substantially the same in the assembly of the preform.

The present invention may exhibit different embodiments that may be taken in combination or individually:

the process comprises an application stage of a contact pressure,

the process comprises a stage involving positioning the preform in a mold,

the process temperature is defined between a transformation temperature of the resin and a temperature above this resin transformation temperature of at least 50° C.,

at the heating stage the preform is moved in the two-sided inductor at a displacement speed, the generation time of the magnetic field depending on the displacement speed.

The present invention likewise relates to a device for the consolidation and induction forming of a preform made of composite material comprising carbon fibers embedded in a resin and oriented in a main direction belonging to a principal plane and likewise comprising particles of ferromagnetic material, the device comprising at least one heating unit provided with at least one two-sided inductor, two walls of which are distributed on both sides of a support on which the preform is positioned, the device likewise comprising means of generating and means of adapting an alternating current, said means being intended for use in generating a uniform magnetic field in a direction of incidence between the two walls of the two-sided inductor, in order to achieve induction heating of the preform up to a defined temperature referred to as the process temperature, said temperature being substantially equal to the Curie temperature of the ferromagnetic material.

According to the invention, this device further comprises means of tilting at least one of the following elements: the preform and the two-sided inductor, so as to orient the direction of incidence of the magnetic field in relation to the principal plane at an angle other than 90° and other than zero.

According to various embodiments of the invention which may be taken in combination or individually:

the two-sided inductor comprises two Helmholtz coils comprising at least two loops, each one of which corresponds to a wall of the two-sided inductor,

the two-sided inductor comprises an even number of loops distributed in pairs on both sides of the support,

said device comprises a mold in which the preform is positioned.

### BRIEF DESCRIPTION OF THE DRAWINGS

The attached figures clearly illustrate how the invention can be realized.

In these figures, the same reference numbers are used to designate similar elements.

FIG. 1 illustrates as a schematic perspective view a particular embodiment of a consolidation device according to the invention,

FIG. 2 illustrates as a schematic profile view the device in FIG. 1,

FIG. 3 is a detailed perspective view of a second embodiment of a device, and

FIG. 4 is a perspective view of the embodiment in FIG. 3.

### DETAILED DESCRIPTION OF THE PREFERRED EMBODIMENTS

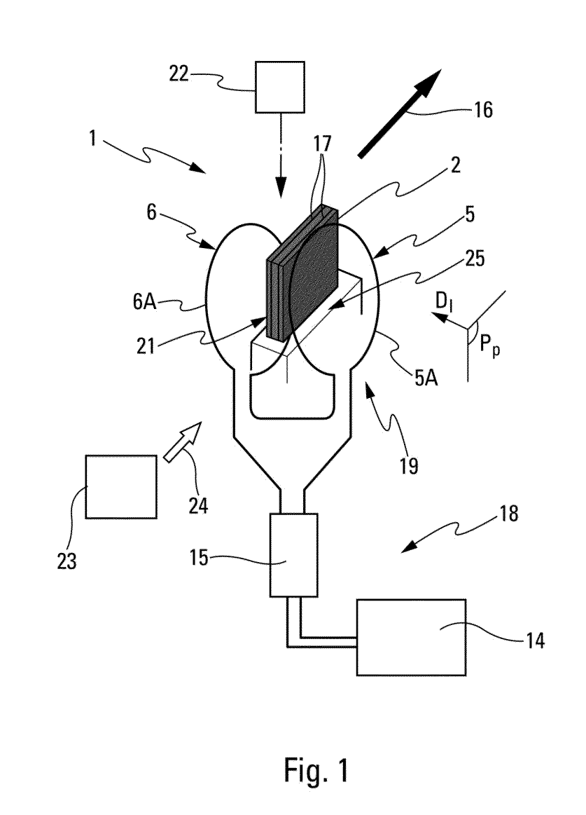

The consolidation device 1, represented in FIGS. 1 to 4, is intended for consolidating a preform 2, made of composite material comprising carbon fibers aligned in a main direction DP and embedded in a resin, the fibers forming folds 17 parallel to a principal plane PP. This principal plane PP is perpendicular to a secondary direction Di, along which contact points may be positioned between the folds 17 during fabrication of the preform 2.

The resin contains a field absorber comprising a ferromagnetic material, the relative magnetic permeability of which is greater than the magnetic permeability of the resin used and greater than that of the carbon of the fibers (relative magnetic permeability μ<2 T.m.A−1), for example of the iron powder (relative magnetic permeability μ=250 T.m.A−1 and Curie temperature=770°). The ferromagnetic material exists in the form of spherical ferromagnetic particles embedded in the resin, for example polysulfone (PSU), with volume fractions of between 10% and 20%. The diameter of the ferromagnetic particles is between 22 microns and 300 microns. The uniformity of the resin/particle mixture depends on the grade of the resin, the granulometry of the ferromagnetic material particles and also the impregnation between the resin and the carbon fibers (fiber/resin interface quality, resin viscosity, porosity rate).

A material is chosen, the Curie temperature of which is substantially equal to a defined temperature referred to as the “process temperature” corresponding, for example, to the transformation temperature of the resin increased by a value of 0 to 50° C. according to the geometry of the preform 2 and final use of the composite material. The Curie temperature corresponds to the temperature at which the ferromagnetic material becomes paramagnetic and, in particular, loses its thermal and electrical conduction properties. The transformation temperature depends on the nature of the resin and is, for example:

either the surfusion temperature in the event that the resin of the preform 2 to be consolidated is made of a semi-crystalline material;

or the fusion temperature (or temperature at which “softening” begins) in the event that the resin of the preform 2 is an amorphous material;

or the polymerization temperature in the event that the resin of the preform 2 to be consolidated is a thermosetting material.

For example, in the case of carbon fibers embedded in a polyether ether ketone resin (referred to as PEEK), the ferromagnetic material used may be NiFe5.

The consolidation device 1 likewise comprises a heating unit 18. The heating unit 18 comprises a two-sided inductor 19, an alternating-current generator 14 and means 15 of adapting this current.

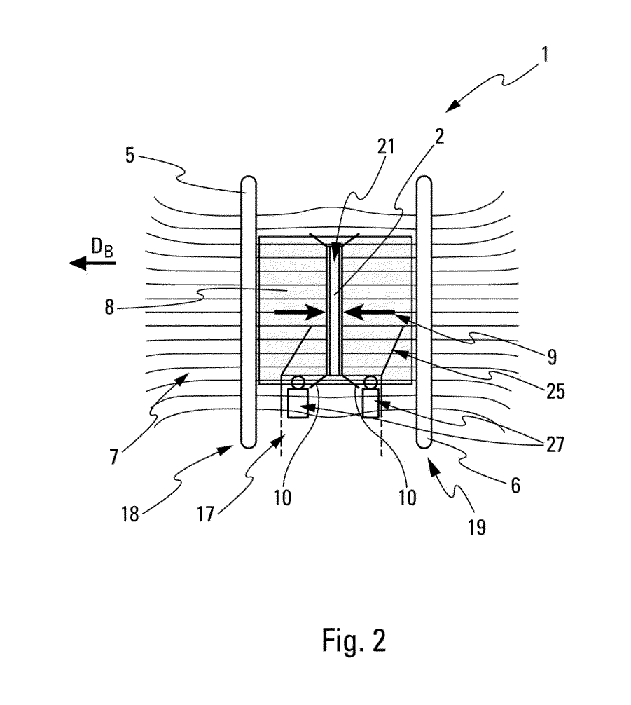

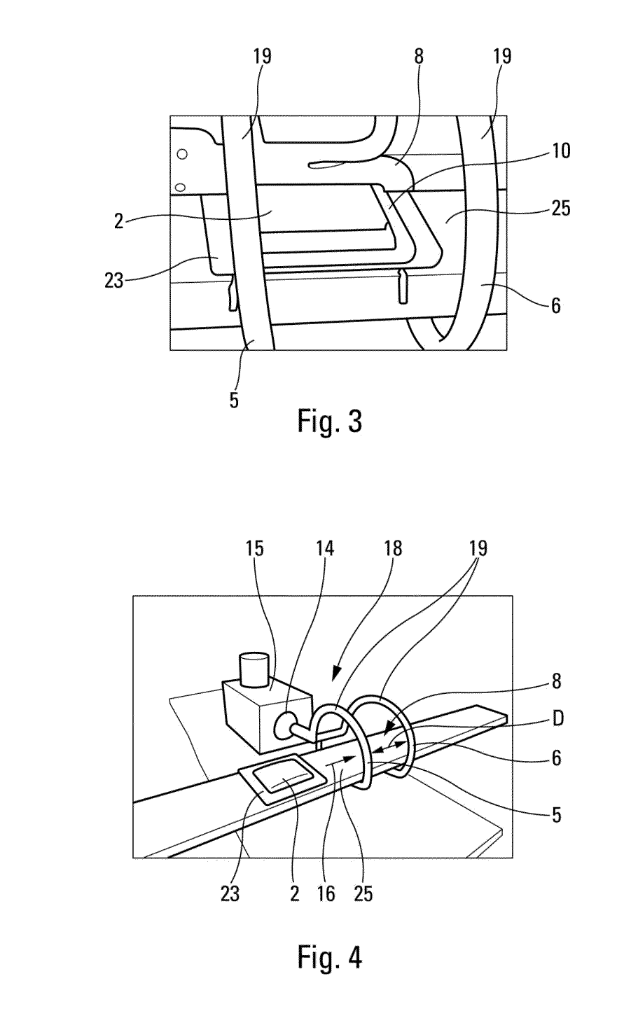

The preform 2 is placed on a support 25 in the zone 8 between two parallel walls 5 and 6 spaced apart from the two-sided inductor 19. A contact pressure 9 (illustrated by arrows 9 in FIG. 2) is applied to the preform 2, for example, as can be seen in FIGS. 3 and 4, covering the preform 2 with a vacuum bladder 23.

The two-sided inductor 19 preferably comprises two Helmholtz coils and the two walls 5, 6 each contain a loop 5A, 6A. The loops 5A, 6A share the same radius. They are arranged parallel to one another and spaced apart from one another at a distance D equal to their radius, as can be seen in FIG. 4.

The application of an alternating current generates a uniform alternating magnetic field 7 between the two loops 5A, 6A. The magnetic field 7 is directed in a direction of incidence DB, as represented in FIG. 2 by field lines 7 perpendicular to the plane of the loops 5A, 6A. Hence, the two-sided inductor 19 allows a uniform magnetic field to be generated over a substantially circular zone 8.

As illustrated in FIG. 2, the device 1 further comprises means of tilting 27 the support 25 intended to orient the preform 2. For example, the tilting means 27 comprise an assembly of at least three pneumatic cylinders situated beneath the sides of the support 25. Hence, through a set of different movements from one cylinder to the other, the preform 2 can be tilted on at least three axes, so that the angle between the direction of incidence DB of the magnetic field 7 and the principal plane PP of the carbon fiber folds is:
other than 90°, in order to limit heating by circulation of induction currents along the main direction DP of the carbon fibers; and
other than 0°, in order to limit heating by induced current circulation at the contact points between folds, along the secondary direction Di. The angle is preferably greater than 5°.

In a preferred embodiment, the magnetic field 7 has a greater frequency (in the order of 1 MHz to 10 MHz) and the power of the magnetic field 7 is greater than 5 000 A/m. These inductive parameters initiate hysteresis heating and limit heating by induced current circulation.

In the presence of a magnetic field of this kind, the ferromagnetic particles are oriented in the direction of the field lines 7. The progressive sequencing of the particles generates induction heating that follows a hysteresis cycle and is referred to as hysteresis heating. The temperature of the preform 2 increases until the ferromagnetic particles lose their spontaneous magnetization property, in other words until the temperature of the preform 2 is equal to the Curie temperature. The uniformity of distribution of the ferromagnetic material particles guarantees the uniformity of the induction heating generated in the preform 2. The geometry of the preform 2 to be consolidated has no impact on the thermal distribution within the preform 2.

This hysteresis heating is additional to that generated by the induction current circulation along the carbon fibers of the composite material. The volume fraction of ferromagnetic particles, the inductive parameters and the tilting between the preform 2 and the walls 5, 6 of the two-sided inductor 19 maximize the hysteresis heating and its dominance over heating by induction current circulation and, when the part temperature is equal to the Curie temperature the heating of the preform is naturally stopped.

Hence, by choosing a ferromagnetic material, the Curie temperature of which is equal to the process temperature, and by adapting the inductive parameters such as the alternating-current frequency and the injected power of the generator 14, the device 1 allows uniform heating to be generated in the preform 2 at a temperature level that is controlled and reproducible, allowing uniform consolidation of the preform 2.

In an embodiment represented in FIG. 1, the device 1 further comprises cooling means 23 including a fluid, such as water or forced air, and an assembly of channels surrounding the preform 2 or the mold 10, as illustrated in FIG. 1 by an arrow 24. Cooling is achieved when the temperature has dropped back below the crystallization temperature of the resin.

In a particular embodiment, the device 1 further comprises means of displacement 22 of the support 25, such as a track associated with a sprocket wheel, which means are capable of moving the preform 2 between the loops 5A and 6A, as indicated by an arrow 16 in FIGS. 1 and 4. The preform 2 is subjected to translational movement in the zone 8 where the magnetic field 7 is uniform. The displacement speed of the preform 2 is controlled such that the exposure time to the magnetic field 7 (between the loops 5A and 6A) is sufficient to reach the transformation temperature of the resin and thereby achieve consolidation of the preform 2.

In this particular embodiment, a production line allows a plurality of preforms to be consolidated by making them circulate by displacement means 22 on the support 25 between the two loops 5A and 6A.

In another particular embodiment for forming, the preform 2 is positioned in a mold 10 and kept in the mold 10 during generation of the magnetic field 7 until the part is consolidated and formed. The mold 10 is, for example, kept on the preform 2 by a contact pressure 9, as represented schematically in FIG. 2.

In one embodiment, the preform 2 is positioned in the mold 10 from installation in the assembly then it is cooled before being removed from the mold. For example, the preform 2 is consolidated for fifteen minutes at the resin transformation temperature and then cooled to 60° C. before being removed from the mold.

In another embodiment, the preform 2 is positioned in the mold 10 following consolidation. For example, the preform 2 is consolidated for fifteen minutes at the resin transformation temperature then cast in a mold for 60 to 90 seconds, depending in particular on the thickness of the preform 2.

The magnetic field 7 is generated for a defined period, in order to consolidate and form the preform 2 to the desired geometry of the part. Once the magnetic field 7 is stopped, the assembly is maintained thanks to the mold 10 until it has cooled sufficiently and the preform 2 has set.

The present invention is not of course limited to the embodiments described above and may extend to any variant exhibiting the aforementioned characteristics. In particular, different embodiments can be combined. Hence, the device 1 can be used to achieve the consolidation and forming of a composite part during the course of the same fabrication stage.

Likewise, the tilting means 27 can be applied to the two-sided inductor 19. In this embodiment (not represented), the two walls 5, 6 of the two-sided inductor 19 are oriented when the support 25 on which the preform 2 is disposed remains fixed. In another embodiment (also not represented), the tilting means 27 may comprise first tilting elements applied to the two-sided inductor 19 and second tilting elements applied to the assembly 21.

Moreover, the device 1 is not limited to Helmholtz coils with two loops. The device 1 may be equipped with a two-sided inductor comprising an even number of loops distributed in pairs on both sides of the support 25. Likewise, the inductor may be a circular or spherical device surrounding the preform 2 to be consolidated and generating a uniform magnetic field about the preform 2. In embodiments of this kind, the means of adaptation 15 of the device 1 are configured in order to supply all or some of the inductor loops, the parameters of the magnetic field 7 thereby generated inside the inductor being dependent on the preform to be consolidated and/or formed.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A process for the consolidation and induction forming of a preform made of a composite material comprising carbon fibers embedded in a resin which are oriented in a main direction belonging to a principal plane, said process comprising the following steps:
preparing a uniform mixture comprising the resin and at least one ferromagnetic material presented in the form of particles;
forming a preform by embedding the carbon fibers in the mixture;
induction heating of the preform up to a defined temperature referred to as the process temperature, said temperature being substantially equal to the Curie temperature of the ferromagnetic material, through generation by means of a two-sided inductor of a uniform magnetic field in the preform in a direction of incidence; and
tilting of at least one of the following elements: the preform and the two-sided inductor, so as to orient the direction of incidence of the magnetic field in relation to the principal plane at an angle other than 90° and other than zero.

2. The process according to claim 1, wherein the process further comprises applying a contact pressure on the preform.

3. The process according to claim 1, wherein the process further comprises a step of positioning the preform in a mold.

4. The process according to claim 1, wherein the process temperature is defined between a transformation temperature of the resin and a temperature above this resin transformation temperature of at least 50° C.

5. The process according to claim 1, wherein at the heating stage the preform is moved in the two-sided inductor at a displacement speed, the generation time of the magnetic field depending on the displacement speed.

6. A device for the consolidation and induction forming of a preform made of composite material comprising carbon fibers embedded in a resin and oriented in a main direction belonging to a principal plane and likewise comprising particles of ferromagnetic material, the device comprising:
at least one heating unit provided with at least one two-sided inductor, two walls of which are distributed on both sides of a support on which the preform is positioned,
means of generating and means of adapting an alternating current, said means being configured to generate a uniform magnetic field in a direction of incidence between the two walls of the two-sided inductor, in order to achieve induction heating of the preform up to a defined temperature referred to as the process temperature, said temperature being substantially equal to the Curie temperature of the ferromagnetic material,
means of tilting at least one of the following elements: the preform and the two-sided inductor, so as to orient the direction of incidence of the magnetic field in relation to the principal plane at an angle other than 90° and other than zero.

7. The device according to claim 6, wherein the two-sided inductor comprises two Helmholtz coils comprising at least two loops, each of which corresponds to a wall of the two-sided inductor.

8. The device according to claim 6, wherein the two-sided inductor comprises an even number of loops distributed in pairs on both sides of the support.

9. The device according to claim 6, further comprising a mold in which the preform is positioned.
